(19) United States
(12) Patent Application Publication
(10) Pub. No.: US 2012/0330575 A1
(43) Pub. Date: Dec. 27, 2012

(54) ESTIMATING ENGINE SYSTEM PARAMETERS BASED ON ENGINE CYLINDER PRESSURE

(75) Inventors: Olaf Weber, Cupertino, CA (US); John Shutty, Clarkston, MI (US); Wolfgang Wenzel, Stuttgart (DE)

(73) Assignee: BORGWARNER INC., Auburn Hills, MI (US)

(21) Appl. No.: 12/442,158

(22) PCT Filed: Oct. 5, 2007
(86) PCT No.: PCT/US07/80537

§ 371 Date: Nov. 30, 2009

Related U.S. Application Data
(60) Provisional application No. 60/851,536, filed on Oct. 13, 2006.

(51) Int. Cl. G01M 15/08; G06F 19/00

(52) U.S. Cl. 702/50; 73/114.16

(57) ABSTRACT

A method includes sensing pressure within an engine cylinder, and estimating at least one other engine system parameter based on the sensed pressure. Another method includes designing an engine system, which includes one or more engine cylinder pressure sensors and one or more other engine system sensors. According to this method, the engine system is operated, and engine cylinder pressure is sensed using the engine cylinder pressure sensors, which are in communication with an engine cylinder of an engine of the engine system. Also, other engine system parameters are sensed to obtain at least one other engine system parameter using the other engine system sensors. The engine cylinder pressure is correlated to the at least one other engine system parameter, and engine cylinder pressure is used to replace or augment the at least one other engine system parameter that correlates to the engine cylinder pressure.

### CROSS-REFERENCE TO RELATED APPLICATIONS

This application claims the benefit of U.S. Provisional Application No. 60/851,536, filed Oct. 13, 2006.

### TECHNICAL FIELD

The field to which the disclosure generally relates includes engine control and diagnostics using measurements of engine cylinder pressure.

### BACKGROUND

An internal combustion engine includes engine cylinders and may include pressure sensors in communication with the cylinders to measure combustion pressure within those cylinders. Signals from the pressure sensors are received by an engine controller, which also receives signals from a multitude of other engine sensors. The controller uses the various signals, including the pressure sensor signals, to adjust engine fueling, aspirating, and ignition timing to optimize engine performance in terms of fuel consumption, exhaust gas emissions, and output power.

### SUMMARY OF EXEMPLARY EMBODIMENTS OF THE INVENTION

One embodiment of a method includes sensing pressure within an engine cylinder, and estimating at least one other engine system parameter based on the sensed pressure.

Another embodiment of a method includes designing an engine system, which includes one or more engine cylinder pressure sensors and one or more other engine system sensors. According to the method, the engine system is operated, engine cylinder pressure is sensed using the engine cylinder pressure sensors, which are in communication with an engine cylinder of an engine of the engine system. Likewise, at least one other engine system parameter is sensed using the other engine system sensors. The engine cylinder pressure is correlated to the at least one other engine system parameter, and engine cylinder pressure is used to replace or augment the at least one other engine system parameter that correlates to the engine cylinder pressure.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates an embodiment of an internal combustion engine system with a multitude of sensors; and

FIG. 2 illustrates another embodiment of an internal combustion engine system with fewer sensors than the embodiment of FIG. 1.

### DETAILED DESCRIPTION OF EXEMPLARY EMBODIMENTS

The following description of the embodiments is merely exemplary in nature and is in no way intended to limit the invention, its application, or uses.

According to a first embodiment of a method, pressure is sensed within an engine cylinder, and at least one other engine system parameter is estimated based on the sensed pressure. In other words, engine cylinder pressure may be used as a proxy for other engine system parameters. Therefore, sensors for the other engine system parameters may be omitted or at least diagnosed using cylinder pressure data. Cylinder pressure data may also be used to diagnose engine system components for failure, damage, corrosion and the like.

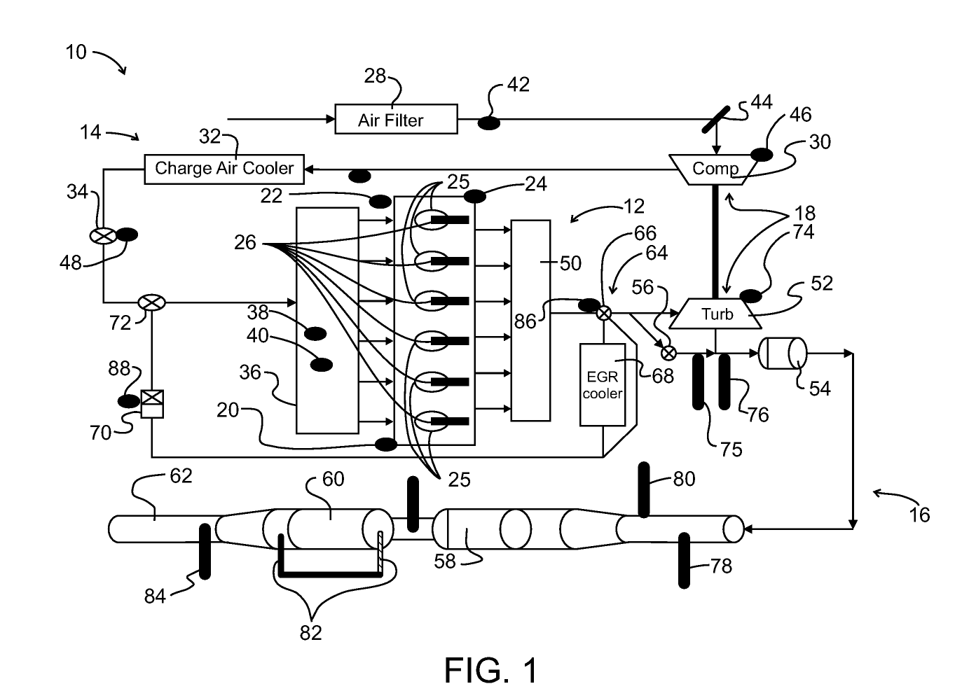

Referring now to FIG. 1, the method may be used in conjunction with an internal combustion engine system 10. In general, the system 10 includes an internal combustion engine 12 to develop mechanical power from combustion of a mixture of air and fuel, an intake or aspiration system 14 to provide air to the engine 12, and an exhaust system 16 to convey combustion gases generally away from the engine 12. Also, the system 10 may include a turbocharger 18 in communication across the aspiration and exhaust systems 14, 16 to compress air for combustion to increase engine output. The turbocharger 18 may be a variable geometry turbine type of turbocharger. Those skilled in the art will recognize that a fuel system (not shown) may be used to provide fuel to the engine, and that a controller (not shown) may include one or more suitable processors and memory to carry out at least some portions of the methods disclosed herein.

The internal combustion engine 12 may be any suitable type of engine, such as an autoignition engine like a diesel engine. The internal combustion engine 12 may use any type of suitable liquid or gaseous fuel. The engine 12 includes cylinders 25 and pistons in a block (not separately shown) that, along with a cylinder head (not separately shown), define combustion chambers (not shown). The engine 12 may also include several sensors. For example, an oil pressure sensor 20 may be provided in the block to measure engine oil pressure, as well as an engine speed and/or position sensor 22 to measure the rotational speed and/or position of an engine crankshaft (not shown). Also, a coolant temperature sensor 24 in the block measures the temperature of engine coolant flowing therethrough.

Finally, the engine 12 may include a number of engine cylinder pressure sensors 26 in communication with the engine cylinders 25 to measure pressure therein. The pressure sensors 26 may be located in immediate communication with the engine cylinders 25, such as for estimating parameters related to the engine's combustion curve. The engine cylinder pressure sensors 26 may be separate devices or may be integrated into other devices, such as glow plugs.

Also, the pressure sensors 26 may be located in upstream or downstream communication with the engine cylinders 25, such as for estimating parameters related to the engine's gas exchange pressure curve (e.g. during opening of intake and exhaust valves). For example, the pressure sensors 26 may be placed in upstream communication in any suitable location in the aspiration system 14, such as in communication with the intake manifold 36. In another example, the pressure sensors 26 may be placed in downstream communication in any suitable location in the exhaust system 16, such as in communication with the exhaust manifold 50.

Although the cylinder pressure sensors 26 may be used in accordance with the methods described herein, they are typically used to enhance engine system control and/or diagnostics. For example, the cylinder pressure sensors 26 may enhance control of cylinder-to-cylinder timing and fueling to compensate for individual cylinder differences. The cylinder pressure sensors 26 may also be used to compensate for fuel octane and cetane differences, and they may be used to perform closed loop ignition control using advanced combustion techniques such as Homogeneous Charge Compression Ignition (HCCI). As will be described further herein below, the methods described herein take advantage of the existence of these cylinder pressure sensors 26 to estimate various other engine system parameters, such as parameters that are normally measured or assessed using other dedicated engine sensors.

The aspiration system 14 may include, in addition to suitable conduit and connectors, an air filter 28 to filter incoming air, a turbocharger compressor 30 to compress the filtered air, an intercooler 32 to cool the compressed air, and a throttle valve 34 to throttle the flow of the cooled air. The aspiration system 14 may also include an intake manifold 36 to receive the throttled air and distribute it to the combustion chambers of the engine 12.

The aspiration system 14 may also include a number of sensors. For example, an intake manifold pressure sensor 38 may be provided in communication with the intake manifold 36 to measure the pressure of air flowing to the engine cylinders 25, and a temperature sensor 40 to measure the temperature of air flowing to the cylinders 25. A mass air flow sensor 42 and ambient temperature sensor 44 may be placed downstream of the air filter 28 and upstream of the turbocharger compressor 30. A speed sensor 46 may be suitably coupled to the turbocharger compressor 30 to measure the rotational speed thereof. A throttle position sensor 48, such as an integrated angular position sensor, may be used to measure the position of the throttle valve 34.

The exhaust system 16 may include, in addition to suitable conduit and connectors, an exhaust manifold 50 to collect exhaust gases from the combustion chambers of the engine 12 and convey them downstream to the rest of the exhaust system 16. The exhaust system 16 may also include a turbocharger turbine 52 in downstream communication with the exhaust manifold 50, a catalytic converter 54 such as a close-coupled diesel oxidation catalyst (DOC) device, and a turbo wastegate valve 56 to control bypass of exhaust gases around the turbocharger turbine 52 to the DOC unit. Also, the exhaust system 16 may include a nitrogen oxide (NOx) adsorber unit 58 upstream of a soot filter 60, which may be upstream of an exhaust tailpipe 62.

Additionally, the exhaust and/or aspiration system(s) 16, 14 may include an exhaust gas recirculation (EGR) apparatus 64 to recirculate exhaust gas from the exhaust manifold 50 of the engine 12 to the intake manifold 36 of the engine 12. The EGR apparatus 64 may include an EGR cooler bypass valve 66 in downstream communication with the exhaust manifold 50 to control recirculation of exhaust gases back to the intake manifold 36, an EGR cooler 68 downstream of the EGR cooler bypass valve 66 to cool EGR gases, and an EGR valve 70 to control flow of the EGR gases. The EGR apparatus 64 may also include an EGR mixing unit 72 in communication with the EGR valve 70 at a location downstream of the throttle valve 34 and upstream of the intake manifold 36 to mix EGR gases with the throttled air.

The exhaust system 16 may further include a number of sensors. A position sensor 74 may be disposed in proximity to the turbocharger 18 to measure the position of the variable geometry turbine, and a NOx sensor 75 may be placed downstream of the turbine 52. Temperature sensors 76, 78 may be placed upstream and downstream of the catalytic converter 54 to measure the temperature of exhaust gases at the inlet and outlet of the catalytic converter 54. An oxygen (O₂) sensor 80 may be placed upstream of the adsorber unit 58 to measure oxygen in the exhaust gases. One or more pressure sensors 82 may be placed across the soot filter 60 to measure the pressure drop thereacross. A tailpipe temperature sensor 84 may be placed just upstream of a tailpipe outlet to measure the temperature of the exhaust gases exiting the exhaust system 16. Finally, a position sensor 86 may be used to measure the position of the EGR cooler bypass valve 66, and another position sensor 88 may be used to measure the position of the EGR valve 70.

In addition to the sensors shown and discussed herein, any other suitable sensors and their associated parameters may be encompassed by the presently disclosed methods. For example, the sensors could also include accelerator pedal sensors, vehicle speed sensors, powertrain speed sensors, filter sensors, flow sensors, vibration sensors, knock sensors, intake and exhaust pressure sensors, turbocharger speed and noise sensors, and/or the like. Moreover, other engine system parameters may be encompassed by the presently disclosed methods, including turbocharger efficiency, component fouling or balancing problems, filter loading, Diesel Particulate Filter (DPF) regeneration status, EGR rate, HP/LP EGR fraction or ratio, cylinder charge mal-distribution, and/or the like. In other words, any sensors may be used to sense any suitable physical parameters including electrical, mechanical, and/or chemical parameters. As used herein, the term sensor includes any suitable hardware and/or software used to sense any engine system parameter.

Also, as used herein, HP EGR may include a high pressure exhaust gas recirculation path between exhaust and induction subsystems upstream of a turbocharger turbine and downstream of a turbocharger compressor, and LP EGR may include a low pressure exhaust gas recirculation path between exhaust and induction subsystems downstream of the turbocharger turbine and upstream of the turbocharger compressor. A target total EGR fraction may determined for compliance with exhaust emissions criteria, and a target HP/LP EGR ratio may be determined to optimize other engine system criteria within the constraints of the determined target total EGR fraction.

The estimated parameters may be quantitative, qualitative, and/or existential in nature. More specifically, numerical parameter values may be estimated, qualitative parameters may be estimated such as component malfunction, and existential parameters may be estimated such as absence or presence of components or of authentic components. Also, values of the parameters may be absolute or relative numerical values, values that indicate absence or presence such as 0 or 1, or any suitable indications for a parameter of any kind.

According to another embodiment, a method is provided for designing an engine system. According to the method, an engine system may be provided and includes one or more engine cylinder pressure sensors and one or more other engine system sensors. For example, the above-described engine system 10 could be used. Next, the engine system may be operated. For example, the engine system may be operated in an instrumented vehicle on a vehicle test track, on a dynamometer, in an emissions test laboratory, and/or the like. During engine system operation, cylinder pressure may be sensed using engine cylinder pressure sensors in communication with engine cylinders of an engine of the engine system. Then, other engine system parameters may be sensed using the other engine system sensors. Values for any or all of the sensed parameters may be stored in any suitable manner for subsequent data analysis.

The parameters may be analyzed or evaluated to correlate engine cylinder pressure to other engine system parameter. Such correlation may be carried out in any suitable fashion. For example, cylinder pressure may be formulaically related to the other engine system parameters. In another example, cylinder pressure may be empirically and statistically related to the other engine system parameters. In any case, where cylinder pressure is found to reliably correlate to any other engine system parameter, that correlation may be modeled formulaically, empirically, acoustically, and/or the like. For example, empirical models may be developed from suitable testing and can include lookup tables, maps, and the like that may cross reference cylinder pressure with other engine system parameters.

Accordingly, engine cylinder pressure measurements are used as a proxy for and, thus, to replace or augment measurements of, other engine system parameters that correlate to engine cylinder pressure. Although cylinder pressure at any given moment during engine operation may be measured, one preferred aspect includes using non-combustion cylinder pressure measurements such as pre-combustion and/or post-combustion pressure. More particularly, engine cylinder pressure may be sensed just before combustion, but substantially when compression is complete, for use with engine system parameters that correlate with such cylinder pressure.

In a first example, the other engine system parameter may be a position of a mechanical device such as a valve. More particularly, the mechanical device position may be variable geometry turbine position, which may be proportional to intake manifold pressure and may be formulaically evaluated or estimated based on engine cylinder pressure using the following equation:

$${P}_{cyl} = {P}_{intake} * {CR}^{k} = {P}_{intake} * {( \frac{{V}_{s} + {V}_{cc}}{{V}_{cc}} )}^{k}$$

where:
P_{cyl}=cylinder pressure before combustion, after compression [Pa];
Pᵢₙₜₐₖₑ=intake manifold pressure [Pa];
CR=compression ratio=(Vₛ+V_{cc})/V_{cc} [dimensionless], wherein Vₛ, V_{cc}=swept volume, and clearance volume [m³]; and
k=ratio of specific heat of air [dimensionless].

In a second example, engine system parameters may be estimated based on engine system acoustics. More particularly, the frequency content of the cylinder pressure sensor signals may be analyzed or evaluated to estimate the other engine system parameters. For example, the frequency spectrum of the cylinder pressure sensor signals or portions thereof may be analyzed to determine the position of a mechanical valve using Fourier analysis, Laplace analysis, Wavelet analysis, and/or the like. Also, such preprocessing may be coupled with, for example, model-based or artificial intelligence approaches like neural networks to evaluate relationships between sensed engine cylinder pressure and at least one other engine system parameter.

Many engine system sub-systems and components may be designed to be easily monitored by their acoustic response behavior, and such acoustic responses may be analyzed and may include acoustic signatures. In fact, engine system components may be designed to exhibit a particular acoustic signature, which the cylinder pressure sensor(s) may be designed to recognize. The acoustic signature may include one or more of amplitude, frequency, or transient characteristics. It is also contemplated that cylinder pressure sensor signals may be used to recognize changes of the acoustic signatures of the sub-systems and components and therefore detect status changes. For example, frequency analysis of cylinder pressure waves could be used to identify counterfeit sub-systems and components, or to determine when a sub-system or component is malfunctioning or is broken. Moreover, such frequency analysis may be used to sense any changes in geometry in an aspiration or exhaust system in terms of actuation, fouling, and damage.

In another embodiment, a pressure sensor or any other acoustic measuring device which is suited to monitor pressure may be placed elsewhere on or in various engine system components (e.g. in the intake or exhaust path) or in the engine compartment to estimate various engine system parameters. In other words, the cylinder pressure sensors may be replaced or supplemented with pressure sensors upstream or downstream of the cylinders.

In a third example, the other engine system parameter may be a fluid condition. More particularly, the fluid condition may be temperature of air in an engine intake manifold, which is related to cylinder pressure and is formulaically estimated using the following equations:

T_{before}_{_{—}}_{combustion}=Tᵢₙₜₐₖₑ_{_{—}}ₐᵢᵣ*CR^{k-1}

where

PV=mRT_{before}_{_{—}}_{combustion} and

$$ρ = \frac{m}{V}$$

so,

$$ρ = \frac{P}{{RT}_{before\_combustion}} = {ρ}_{before\_combustion}$$

where:

CR=compression ratio;

k=ratio of specific heat of air;

R=air specific gas constant [kJ/(kg*K)];

P=combustion chamber pressure [kPa];

V=cylinder clearance volume [m³];

ρ=air density [kg/m³]; and

T=combustion chamber temperature [K].

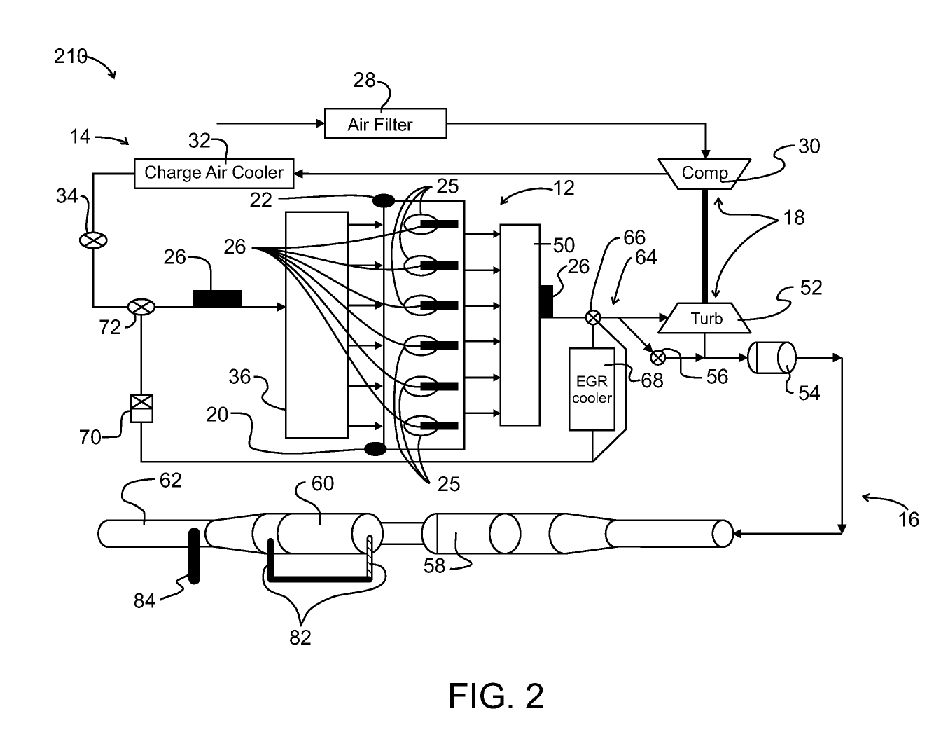

According to the above, the engine cylinder pressure sensors may be used as a check on certain other engine system sensors such as for engine system diagnostics (e.g. On Board Diagnostics—OBD) or the like, or the engine cylinder pressure sensors may be used to omit those other engine system sensors altogether. In other words, engine cylinder pressure may be used not necessarily to improve engine performance, but rather to enhance reliability of measuring engine system parameters and/or eliminate costly sensors from the engine system, as depicted below in FIG. 2.

FIG. 2 illustrates another embodiment of an internal combustion engine system 210. This embodiment is similar in many respects to the embodiment of FIG. 1 and the description of the common subject matter generally may not be repeated here. In fact, the system 210 is nearly identical to the system 10 of FIG. 1, except many of the sensors of the FIG. 1 system 10 are omitted based on the above-described method. One difference includes pressure sensors 26, which instead of or in addition to the sensors 26 in direct communication with the engine cylinders 25, may be placed upstream and/or downstream of the engine cylinders 25 in the intake and/or exhaust system(s) 14, 16.

Accordingly, many sensors may be eliminated, thereby saving on their cost and weight. Alternatively, the sensors may be retained, and the cylinder pressure estimate of the sensors anticipated value may be used as a diagnostic on the other sensor. In this latter case, a direct piece part cost reduction is not achieved, however, simpler and more robust diagnostic algorithms may be used which can save development time and testing as well as engine controller memory and computing time.

The above description of embodiments of the invention is merely exemplary in nature and, thus, variations thereof are not to be regarded as a departure from the spirit and scope of the invention.

1. A method comprising:
sensing pressure within an engine cylinder; and
estimating at least one other engine system parameter based on the sensed pressure.

2. The method of claim 1, wherein the at least one other engine system parameter is a position of a mechanical device.

3. The method of claim 2, wherein the mechanical device position is variable geometry turbine position.

4. The method of claim 1, wherein the at least one other engine parameter is a fluid condition.

5. The method of claim 4, wherein the fluid condition is temperature of air in an engine intake manifold.

6. The method of claim 1, wherein the estimation is also made using formulaically estimated relationships between the sensed pressure and the at least one other engine system parameter.

7. The method of claim 1, wherein the estimation is also made using empirically estimated relationships between the sensed pressure and the at least one other engine system parameter.

8. The method of claim 1, wherein the estimation is also made using artificial intelligence to evaluate relationships between the sensed pressure and the at least one other engine system parameter.

9. The method of claim 1, wherein the at least one other engine system parameter is variable geometry turbine (VGT) position, which is proportional to intake manifold pressure and is formulaically estimated based on engine cylinder pressure and using the following equation:
$${P}_{cyl} = {P}_{intake} * {CR}^{k} = {P}_{intake} * {( \frac{{V}_{s} + {V}_{cc}}{{V}_{cc}} )}^{k}$$
where:
P_{cyl}=cylinder pressure before combustion after compression [Pa];
Pᵢₙₜₐₖₑ=intake manifold pressure [Pa];
CR=compression ratio=(Vₛ+V_{cc})/V_{cc} [dimensionless], wherein Vₛ, V_{cc}=swept volume, and clearance volume [m³]; and
k=ratio of specific heat of air [dimensionless].

10. The method of claim 1, wherein the at least one other engine system parameter is engine intake air temperature, which is formulaically estimated using the following equations:
T_{before}_{_{—}}_{combustion}=Tᵢₙₜₐₖₑ_{_{—}}ₐᵢᵣ*CR^{k-1}
where
PV=mRT_{before}_{_{—}}_{combustion} and
$$ρ = \frac{m}{V}$$
so,
$$ρ = \frac{P}{{RT}_{before\_combustion}} = {ρ}_{before\_combustion}$$
where:
CR=compression ratio;
k=ratio of specific heat of air;
R=air specific gas constant [kJ/(kg*K)];
P=combustion chamber pressure [kPa];
V=cylinder clearance volume [m³];
ρ=air density [kg/m³]; and
T=combustion chamber temperature [K].

11. The method of claim 1, wherein the estimation is made using acoustic relationships between the sensed pressure and the at least one other engine system parameter.

12. The method of claim 11, wherein the estimation is made by analyzing frequency of the sensed pressure.

13. The method of claim 12, wherein the sensing is carried out in the intake system upstream of the engine cylinder.

14. The method of claim 12, wherein the sensing is carried out in the exhaust system downstream of the engine cylinder.

15. The method of claim 11, wherein the sensing is carried out in the intake system upstream of the engine cylinder.

16. The method of claim 11, wherein the sensing is carried out in the exhaust system downstream of the engine cylinder.

17. The method of claim 1, wherein the at least one other engine system parameter is an acoustic signature of a component designed to exhibit a particular acoustic signature.

18. The method of claim 17, wherein the acoustic signature includes at least one of amplitude, frequency, or transient characteristics.

19. The method of claim 17, wherein the acoustic signature is estimated to identify a component that is at least one of counterfeit, broken, or malfunctioning.

20. A method of designing an engine system, comprising:
providing an engine system including one or more engine cylinder pressure sensors and one or more other engine system sensors;
operating the engine system;
sensing engine cylinder pressure using the engine cylinder pressure sensors, which are in communication with an engine cylinder of an engine of the engine system;
sensing at least one other engine system parameter using the other engine system sensors;
correlating the engine cylinder pressure to the at least one other engine system parameter; and
using engine cylinder pressure to replace or augment the at least one other engine system parameter that correlates to the engine cylinder pressure.

21. The method of claim 1, wherein the sensing step is carried out using a cylinder pressure sensor, and the at least one other engine system parameter is normally measured with an other sensor.

22. The method of claim 21, wherein the pressure sensed by the cylinder pressure sensor is used to augment the at least one other engine system parameter measured by the other sensor.

23. The method of claim 21, wherein the pressure sensed by the cylinder pressure sensor is used to replace the at least one other engine system parameter measured by the other sensor.

24. The method of claim 1, wherein the at least one other engine system parameter includes at least one of a position of a mechanical device, a fluid condition, or an acoustic signature of a component.

25. The method of claim 1, wherein the sensed pressure is non-combustion cylinder pressure.

26. The method of claim 1, wherein the sensing step is carried out before combustion but after compression.
